(19) United States
(12) Patent Application Publication
(10) Pub. No.: US 2026/0017297 A1
(43) Pub. Date: Jan. 15, 2026

(54) SYSTEMS AND METHODS FOR INTERFACING WITH DATA PROFILERS USING A MACHINE LEARNING MODEL

(71) Applicant: Capital One Services, LLC, McLean, VA (US)

(72) Inventors: Taylor TURNER, Richmond, VA (US); Jeremy GOODSITT, Champaign, IL (US)

(73) Assignee: Capital One Services, LLC, McLean, VA (US)

(21) Appl. No.: 18/772,068

(22) Filed: Jul. 12, 2024

(51) Int. Cl. G06F 16/33; G06F 16/242; G06F 40/284

(52) U.S. Cl. CPC G06F 16/3337; G06F 16/2438; G06F 40/284

(57) ABSTRACT

Systems and methods for interfacing with data profilers using a machine learning model. In some aspects, the system receives a data profiler configured to create and interface with a plurality of data profiles. The system trains a profile query model to generate responses to user queries relating to data profiles. The system receives a user query concerning data profiles associated with the data profiler. Using an interpretation model, the system pre-processes the user query and data profile attributes to determine an activation pattern for the profile query model. The system uses the profile query model to process the user query and the data profile attributes of the data profiler and generate a preliminary response. The system post-processes the preliminary response to generate a verified response by applying a corrective program. The system then transmits the verified response in a conversational program related to the user query.

### SUMMARY

Methods and systems are described herein for novel uses and/or improvements to artificial intelligence applications. As one example, methods and systems are described herein for a machine learning architecture allowing interaction with complex data profiles and capable of producing sophisticated responses regarding data profile attributes.

Conventional systems for providing textual responses using machine learning models often lack guardrails for factual accuracy or data confidentiality or security. Conventional systems for language-based machine learning models break down in the face of complicated data processing tasks such as summarizing dataset attributes or searching data profiles, often returning responses with inaccuracies or irrelevant responses. Large language models such as Llama or ChatGPT are prone to false statements of fact, or “hallucinations”, particularly with regards to numerical data. This is due to a generic approach by such machine learning models in answering user queries; these models lack specific adaptions for tasks with such complexity and distinctiveness.

By contrast, systems and methods described herein use pre-processing on a user query relating to data profile attributes to determine the appropriate activation pattern for a profile query model. The pre-processing uses an interpretation model to translate the user query into embeddings, based on which the system can select the required input data, supplemental software programs, and/or specific algorithms for use by the profile query model. Thus, the profile query model is able to make a targeted response closely tailored to the intention of the user query. The system additionally post-processes the preliminary response output by the profile query model to ensure factual accuracy, relevance, and other formatting requirements. The result is a machine learning architecture far better adapted to providing pertinent and reliable answers regarding data profiles.

In some aspects, methods and systems are described herein comprising receiving a data profiler configured to create and interface with a plurality of data profiles; training a profile query model to generate responses to user queries relating to data profiles based on training data comprising data profile attributes from the data profiler; receiving a user query concerning one or more data profiles associated with the data profiler; using an interpretation model, pre-processing the user query and one or more data profile attributes of the data profiler to determine an activation pattern for the profile query model, wherein the interpretation model is trained to produce real-valued embeddings associated with user queries; using the profile query model to process the user query and the one or more data profile attributes of the data profiler and generate a preliminary response; post-processing the preliminary response to generate a verified response by applying a corrective program, wherein the verified response is checked for accuracy and confidentiality; and transmitting the verified response in a conversational program related to the user query.

Various other aspects, features, and advantages of the systems and methods described herein will be apparent through the detailed description and the drawings attached hereto. It is also to be understood that both the foregoing general description and the following detailed description are examples and are not restrictive of the scope of the systems and methods described herein. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for a system for interfacing with data profilers using a machine learning model, in accordance with one or more embodiments.

FIG. 2 shows translating between natural language text and real-valued embeddings using a machine learning model, in accordance with one or more embodiments.

FIG. 3 shows illustrative components for interfacing with data profilers using a machine learning model, in accordance with one or more embodiments.

FIG. 4 shows a flowchart of the steps involved in interfacing with data profilers using a machine learning model, in accordance with one or more embodiments.

### DETAILED DESCRIPTION

In the following description, for the purposes of explanation, numerous specific details are set forth in order to provide a thorough understanding of the embodiments described herein. It will be appreciated, however, by those having skill in the art that the embodiments may be practiced without these specific details or with an equivalent arrangement. In other cases, well-known structures and devices are shown in block diagram form in order to avoid unnecessarily obscuring the embodiments.

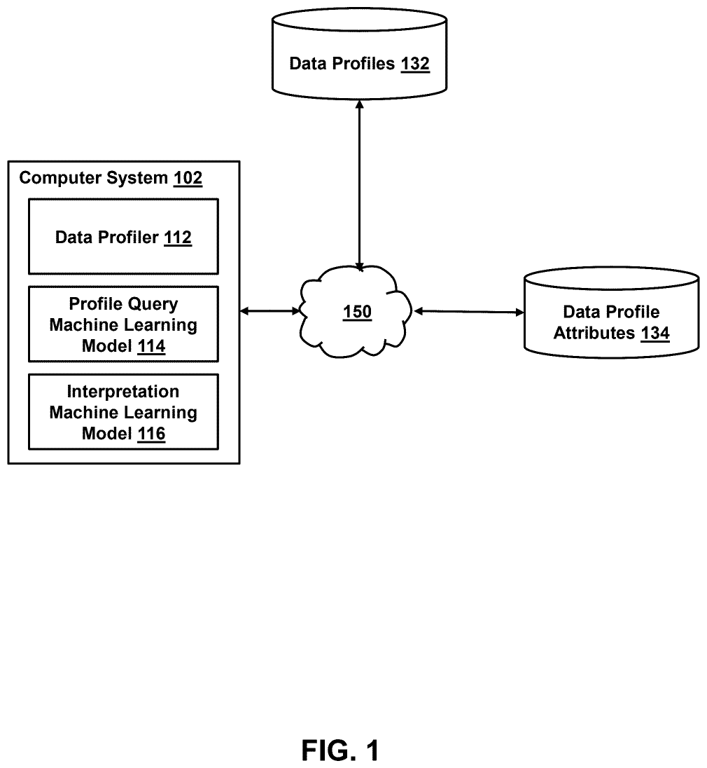

FIG. 1 shows an illustrative diagram for system 150, which contains hardware and software components used to interfacing with data profilers using a machine learning model, in accordance with one or more embodiments. For example, Computer System 102, a part of system 150, may include Data Profiler 112, Profile Query Machine Learning Model 114, and Interpretation Machine Learning Model 116. System 150 may create, store, or otherwise interact with Data Profiles 132 and Data Profile Attributes 134.

System 150 (the system) may be deployed to a conversational program taking user queries regarding aspects of data profiles generated by a data profiler (e.g., Data Profiler 112). In some embodiments, a data profiler or suitable library may receive a dataset and generate a data profile for the dataset, such as information or metadata describing the dataset. This information or metadata may include a dictionary, a nested dictionary of values, or other suitable information describing the dataset. For example, Data Profiler 112 is configured to create and store data profiles such as Data Profiles 132. Each data profile in Data Profiles 132 may be generated based on a dataset, a data sample, or a selection from a database. A dataset may, for example, include features describing quantities or categories. Features may be numerical, categorical, ordinal or temporal, and the dataset may consist of feature values for a set of features. Data Profiler 112 may generate the data profile by performing an exploratory data analysis to extract certain pertinent features of the dataset. Data Profiler 112 may generate a data profile to give high-level overview which aids in the discovery of data quality issues as well as enabling downstream processing for tasks such as quantitative prediction or classification. To generate a data profile, Data Profiler 112 may use a deterministic program to detect dataset characteristics such as mean, minimum, maximum, percentiles, quartiles, and frequency for one or more features in the dataset. Data Profiler 112 may generate metadata based on the dataset describing, for example, the frequency of null values or the distributions of values for features. In some embodiments, Data Profiler 112 may perform dimensionality reduction in an exploration of the features in the dataset, for example using a principal component analysis technique. The resulting dimensions. Additionally, Data Profiler 112 may generate multivariate metadata including correlations between features such as covariance matrices. In some embodiments, Data Profiler 112 may build simple models such as linear regression models to explore the relationships between features.

To generate Data Profiles 132, Data Profiler 112 may perform some or all of the above operations to datasets. Data Profiler 112 may selectively apply some techniques to some datasets as needed. For example, the system may decide to seek a particular data profile attribute (e.g., Data Profile Attributes 134) from a dataset. The system may particularly need to know of the distribution of features in one dataset, for example, and be more interested in the covariance between features in a different dataset. Thus, the data profile may contain different set of data profile attributes. As referred to herein, a data profile attribute is a metric or other numeric representation generated for a data profile (such as one in Data Profiles 132), describing one or more aspects of the underlying dataset. Data profile attributes might be real values capturing the standard deviations for one or more features in a dataset, or the mean, minimum, maximum, percentiles, quartiles, or frequency distributions for features. Each data profile in Data Profiles 132 may correspond to one or more data profile attributes in Data Profile Attributes 134, stored in the computer system's memory.

The system may receive training data containing a first set of features, which may be used as input by a machine learning model (e.g., Profile Query Machine Learning Model 114). The training data may include data profile attributes and user queries. For example, Profile Query Machine Learning Model 114 can be trained to produce responses to textual user queries through responses, where the user queries pertain to user profiles. The training data may transform past user queries into a text-token format. Each word, sentence, paragraph or other semantic element is represented as a text token, which may be translated to a real-valued embedding. Profile Query Machine Learning Model 114 is trained to process an input sequence of text tokens, for example in embedding format, and produce an output text sequence to serve as a response, for example answering the user's question regarding an aspect of a data profile. Profile Query Machine Learning Model 114 can be trained using algorithms such as deep neural networks or Bidirectional Encoder Representation Transformer algorithms. Profile Query Machine Learning Model 114 may be trained using the gradient descent or backpropagation parameter tuning method, and may be evaluated on a loss function assessing adherence to the training dataset. In some embodiments, Profile Query Machine Learning Model 114 may be trained in an unsupervised or semi-supervised learning scheme to produce responses to input queries.

The system may receive a user query regarding a data profile in Data Profiles 132. For example, the user query may pertain directly or indirectly to a data profile attribute in Data Profile Attributes 134. The user may submit a query to the system such as “What is the mean and standard deviation for square footage in the house value dataset?” or “Fit a linear regression model to predict house value. Show the parameters”. The user queries may be received similarly to the training data for Profile Query Machine Learning Model 114, being divided into word tokens and translated into real-valued embeddings. The user query's embedding may be used as input to Profile Query Machine Learning Model 114 to generate a preliminary response. Prior to doing so, however, the system may use an interpretation machine learning model to perform pre-processing in order to assess a plan of action regarding the user query.

The system may use an interpretation machine learning model (e.g., Interpretation Machine Learning Model 116) to determine an activation pattern appropriate for the user query. An activation pattern describes how Profile Query Machine Learning Model 114 generates a response to the user query. For example, the activation pattern describes the manner in which a machine learning model transforms its input values into an output. For example, an activation pattern may describe an algorithm used by the machine learning model to generate a text sequence in response to input values. In another example, an activation pattern may describe the parameters, weights, biases, and loss functions of a machine learning model used in computation. In some embodiments, the system may choose activation patterns from pre-set standard activation patterns. For example, the algorithm for a machine learning model may be chosen from standard options corresponding to categories of incoming user requests. An activation pattern may also describe additional software programs used to aid a machine learning model. For example, a machine learning model may use a clustering program to classify its inputs before the model does further processing to generate an output. In another example, an activation pattern may use a program to process its output into a format suitable for a preliminary response. For example, the machine learning model may generate an output indicating a piece of advice in a real-valued format. The system may wish to present the preliminary response in a text format, and may thus use an embedding program to translate the real-valued output of the machine learning model into the preliminary response.

Interpretation Machine Learning Model 116, in conjunction with other programs the system may interface with, may perform pre-processing of the user query in preparation for Profile Query Machine Learning Model 114 to generate the preliminary response. As referred to herein, pre-processing includes identifying supplemental data and formatting requirements. Additionally, the retrieval of the supplemental data may also be considered pre-processing. Supplemental data refers to data that may be used as input to a machine learning model that is not directly taken from the user query. For example, the system may seek to retrieve one or more attributes in Data Profile Attributes 134, perform basic data cleansing, and use the data for input to Profile Query Machine Learning Model 114. The data profile attributes may be used in generating a response to the user query. For example, for a query asking for a histogram of median values for a feature across datasets, Interpretation Machine Learning Model 116 may classify the query as visual generation based on data. Interpretation Machine Learning Model 116 may therefore find the raw data associated with the query, in this case, the median for the feature across the specified datasets. If the median is not present in Data Profile Attributes 134, Interpretation Machine Learning Model 116 may simply return the raw datasets with the feature. Otherwise, Interpretation Machine Learning Model 116 outputs the median for the features in the datasets for use by Profile Query Machine Learning Model 114 in generating a preliminary response.

The system may select activation patterns for Profile Query Machine Learning Model 114 by classifying the user query into a category using Interpretation Machine Learning Model 116. Interpretation Machine Learning Model 116 is trained to take a user query as input and, using an embedding map generated by training on a dataset of user queries, to translate the input query to a real-valued embedding. For example, Interpretation Machine Learning Model 116 may be provided with a set of pre-determined categories supplied through its training dataset. Interpretation Machine Learning Model 116 may be trained to classify an input user query, in real-valued embedding form, into a category in the set. Each category may be associated with an activation pattern. In some embodiments, Interpretation Machine Learning Model 116 may instead be trained to output an activation pattern directly. Additionally or alternatively, Interpretation Machine Learning Model 116 may also output a formatting requirement for the post-processing of the preliminary response into a verified response. The formatting requirement may specify requirements for privacy in the verified response, and may additionally include mathematical formulae used to determine the factual accuracy of the preliminary response.

The system then uses Profile Query Machine Learning Model 114 to generate a preliminary response by taking as input the real-valued embeddings representing the user query. Profile Query Machine Learning Model 114 may use a variety of algorithms such as deep neural networks and transformer-based text processing algorithms to perform next-token prediction in order to build a sequence of embeddings corresponding to a response. Profile Query Machine Learning Model 114 may be trained on data consisting of responses to user queries relating to data profile attributes, and its output during training consists of preliminary responses containing information about those data profile attributes. For example, Profile Query Machine Learning Model 114 produces “the median for square footage in the housing dataset is 800” in response to a query asking “what is the median square footage in this housing dataset?”. The preliminary response may contain text in natural language, but may also include descriptions of data profile attributes, or computed results based on data profiles. In some embodiments, the preliminary response may include graphics or other generated results the user query may request. Profile Query Machine Learning Model 114 may use its sequential token-processing architecture to generate responses to these other queries, incorporating what data from Data Profile Attributes 134 is deemed necessary based on its activation pattern.

The system post-processes the preliminary response to generate a verified response. The system may use a verification program (also referred to as a corrective program) to verify factual accuracy and confidentiality of the preliminary response. Interpretation Machine Learning Model 116 may also generate a formatting requirement for post-processing of the preliminary response by a corrective program. A formatting requirement, as referred to herein, is a restriction on the presentation of responses to user queries. Restrictions may include requirements for content of a response or the style of presentation for the response. For example, a formatting requirement may require the tone of a response to be suggestive and friendly rather than directive or dismissive. In another example, the formatting requirement may require the response to be free of identifying personal information out of privacy concerns for the user. In another example, the formatting requirement may adjust the confidence level of a response in order to avoid over-promising when executing a task. Formatting requirements may be used to inform the pre-processing or post-processing of the machine learning model before or after generating a preliminary response. The formatting requirement may also specify the factual accuracy of the preliminary response, to be confirmed using the user query. The formatting requirement generated by Interpretation Machine Learning Model 116 may specify that the verification program retrieve data profile attributes from Data Profile Attributes 134 and perform mathematical formulae to generate a real-valued result expected of the preliminary response as a factual accuracy check.

For example, the verification program may scan the verified response for any confidential information listed in a dataset of restricted information. For example, the verification program may remove any mention of restricted datasets, refusing all queries relating to the restricted data. In another example, the verification program may scrub the preliminary response of personally identifying information, such as names, home addresses, and similar personal data. Additionally or alternatively, the verification program may check the factual accuracy of the preliminary response by applying a mathematical formula to one or more data profile attributes. For example, the verification program may retrieve data in accordance with the formatting requirement from Data Profile Attributes 134. The verification program may retrieve a null type and a null value distribution from Data Profile Attributes 134. Based on the formatting requirement, the null value distribution must be sufficiently low and the null type must avoid certain core feature values in order for the system to consider the user query feasible. The verification program may determine a measure of correspondence with the activation pattern prescribed for Profile Query Machine Learning Model 114 indicating the degree of confidence the system has that the preliminary response is correct. If the measure of correspondence is below a threshold, the system may choose not to transmit the preliminary response and instead reject the user query. In another example, the system may use the mathematical formulae, combined with data profile attributes from Data Profiles 132, to calculate an expected result. The expected result is a real value associated with the user query that the verification program generates independently of Profile Query Machine Learning Model 114. The verification program may refer to the formatting requirement or activation patterns output by Interpretation Machine Learning Model 116 to choose a mathematical formula and required input data. It may perform a computation to determine the expected result for the user query, and compare the result extracted from the embedding of the preliminary response against the expected result. The system may correct the preliminary response to use the expected result in cases of difference.

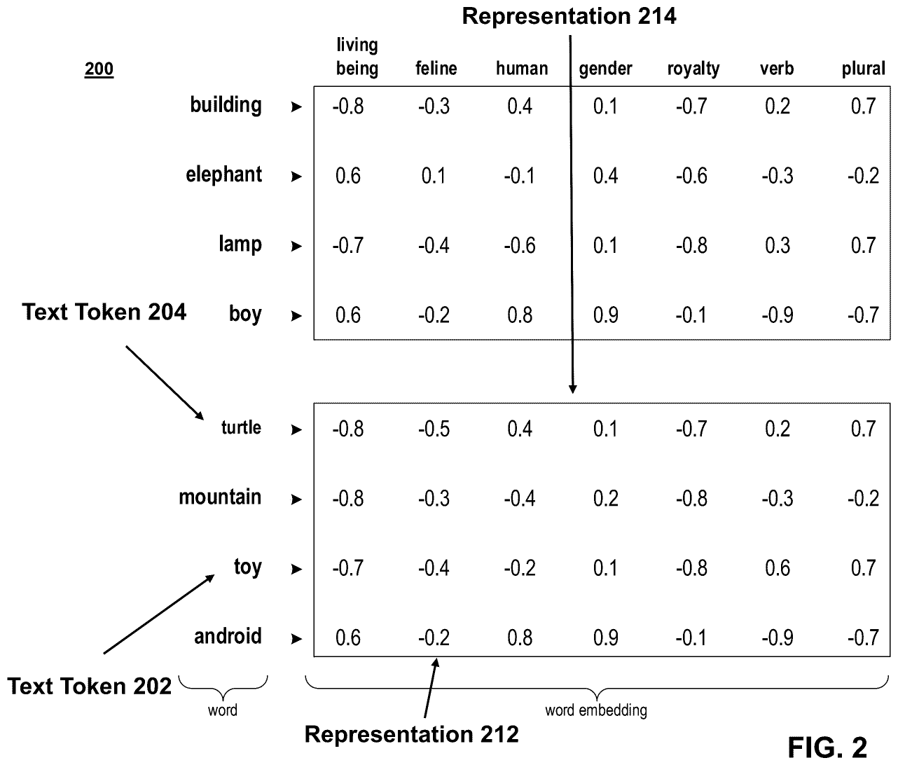

FIG. 2 shows illustration 200 for text tokens being projected to representations in a real-valued space. For example, Text Token 202 comprises the word “toy” and Text Token 204 comprises the word “turtle”. In some embodiments, some text tokens may include sentences or paragraphs instead of words. Alternatively, numbers, symbols, or punctuation may also be text tokens. Each text token may correspond to a representation. For example, Text Token 202 corresponds to Representation 212, a vector of real values: [−0.7, −0.4, −0.6, 0.1, −0.8, 0.3, 0.7]. The vector of real values is associated with a set of features, each of which correlates with an attribute which may be associated with a word. Text Token 204 may be associated with Representation 214, which is a vector of different real numbers associated with the same set of features: [−0.8, −0.3, 0.4, 0.1, −0.7, 0.2, 0.7]. For example, some features may correlate with whether a word signifies a human, what gender the word would be, or whether the word is a verb. In some embodiments, sentences, paragraphs, and symbols may be associated with a set of features different from the set used for words.

The system may generate embeddings for user queries to pre-process them using Interpretation Machine Learning Model 116. For example, the system may use an embedding to classify a user query into a category, the category corresponding to a predefined standard activation pattern. Additionally or alternatively, the system may select formatting requirements based on the embedding. In some embodiments, the system may train Interpretation Machine Learning Model 116 to perform classification to thereby choose a preset activation pattern in the category. In some other embodiments, the system may instead train Interpretation Machine Learning Model 116 to produce outputs directly specifying activation patterns and formatting requirements by taking as input the embedding of the user query. For example, Interpretation Machine Learning Model 116 may be trained to correspond elements of embeddings with certain requirements of input data for Profile Query Machine Learning Model 114.

The system may also use embeddings to generate a preliminary response. For example, Profile Query Machine Learning Model 114 may be a language processing model trained to take an input embedding corresponding to a user query and output a textual response. Profile Query Machine Learning Model 114 may use a variety of algorithms such as deep neural networks and transformer-based text processing algorithms to perform next-token prediction in order to build a sequence of embeddings corresponding to a response. Profile Query Machine Learning Model 114 may be trained on data consisting of responses to user queries relating to data profile attributes, and its output during training consists of preliminary responses containing information about those data profile attributes. Profile Query Machine Learning Model 114 may use embeddings of previous user queries to build context and perform intention tuning for the incoming user query to build a more precise preliminary response.

The system may examine the embeddings of a preliminary response when performing post-processing to verify factual accuracy. For example, the verification program may examine the embedding of the preliminary response to determine appropriate mathematical formulae to apply. The verification program may correlate certain embedding values with types of content declared in a response. For example, if the preliminary response claims to provide a mean value for a feature, the verification program correspondingly knows to check for the mean value of the feature and compare it against that provided in the preliminary response. Alternatively, the verification program may use the embeddings to determine a relation between features. If the preliminary response includes a graphic demonstrating relationships between two features, as shown by its embeddings, the verification program may confirm the data integrity of the features.

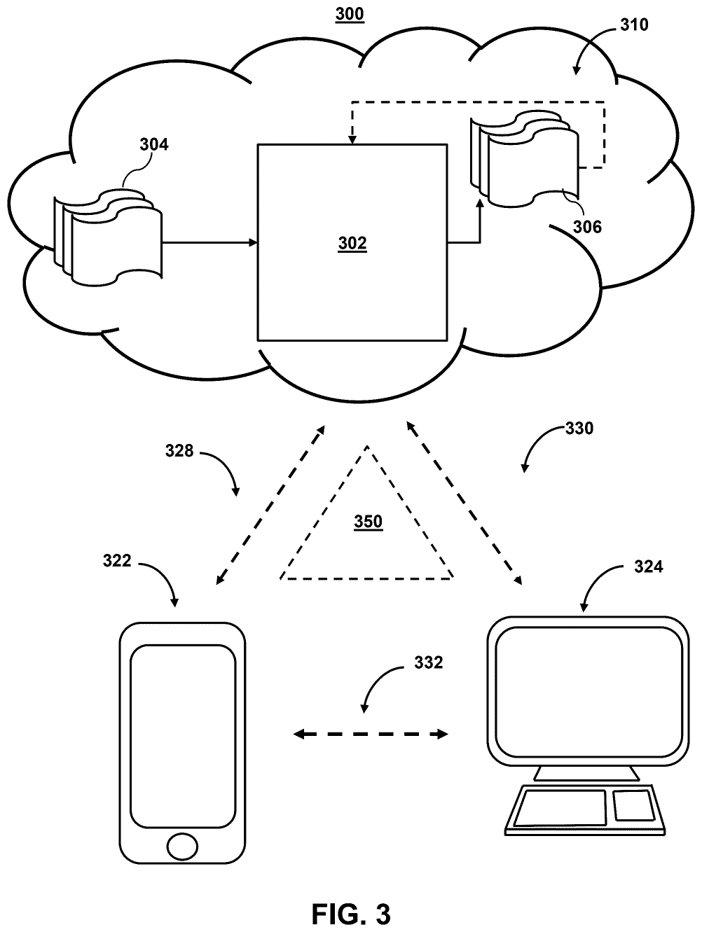

FIG. 3 shows illustrative components for a system used to communicate between the system and user devices and collect data, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and other computer equipment (e.g., a server), including “smart,” wireless, wearable, and/or mobile devices. FIG. 3 also includes cloud components 310. Cloud components 310 may alternatively be any computing device as described above, and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (hereinafter “I/O”) paths. Each of these devices may also include processors and/or control circuitry to send and receive commands, requests, and other suitable data using the I/O paths. The control circuitry may comprise any suitable processing, storage, and/or input/output circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., queries, responses including data profile attributes, and/or notifications).

Additionally, as mobile device 322 and user terminal 324 are shown as touchscreen smartphones, these displays also act as user input interfaces. It should be noted that in some embodiments, the devices may have neither user input interfaces nor displays and may instead receive and display content using another device (e.g., a dedicated display device such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices.

Cloud components 310 may include model 302, which may be a machine learning model, artificial intelligence model, etc. (which may be referred collectively as “models” herein). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction.

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, back propagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be A REST or Web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP Web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful Web-services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: Front-End Layer and Back-End Layer where microservices reside. In this kind of architecture, the role of the API layer 350 may provide integration between Front-End and Back-End. In such cases, API layer 350 may use RESTful APIs (exposition to front-end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API Platforms and their modules. API layer 350 may use a developer portal. API layer 350 may use strong security constraints applying WAF and DDoS protection, and API layer 350 may use RESTful APIs as standard for external integration.

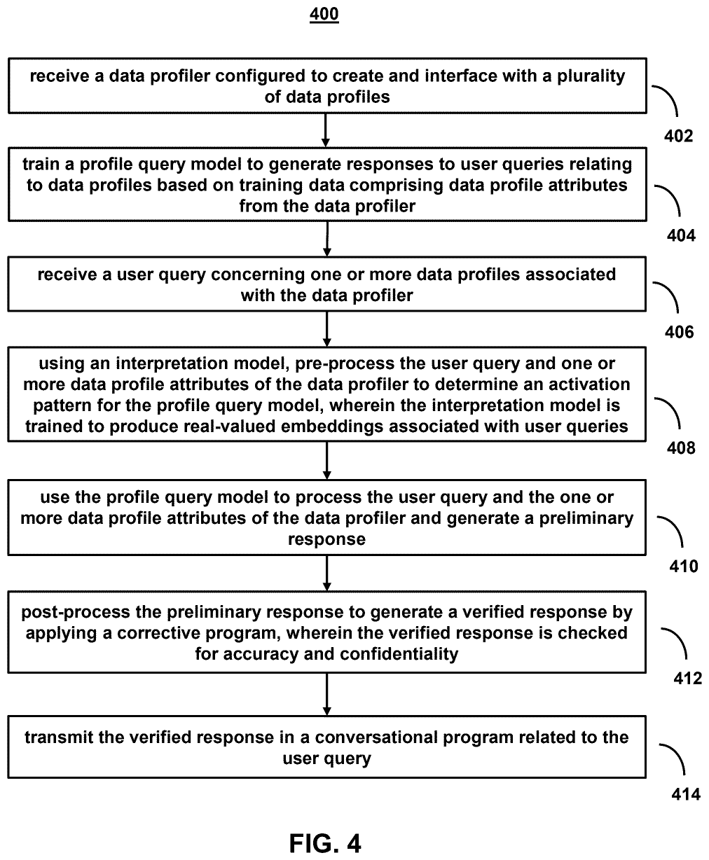

FIG. 4 shows a flowchart of the steps involved in providing search query responses using adjacent keywords and search filters, in accordance with one or more embodiments. For example, the system may use process 400 (e.g., as implemented on one or more system components described above) in order to generate adjacent keywords based on embeddings of search queries, compute similarity and popularity metrics for each adjacent keyword, generate filters based on adjacent keywords, and use filters to provide responses to search queries.

At step 402, process 400 (e.g., using one or more components described above) receives a data profiler configured to create and interface with a plurality of data profiles. System 150 (the system) may be deployed to a conversational program taking user queries regarding aspects of data profiles generated by a data profiler (e.g., Data Profiler 112). For example, Data Profiler 112 is configured to create and store data profiles such as Data Profiles 132. Each data profile in Data Profiles 132 may be generated based on a dataset, a data sample, or a selection from a database. A dataset may, for example, include features describing quantities or categories. Features may be numerical, categorical, ordinal or temporal, and the dataset may consist of feature values for a set of features. Data Profiler 112 may generate the data profile by performing an exploratory data analysis to extract certain pertinent features of the dataset. Data Profiler 112 may generate a data profile to give high-level overview which aids in the discovery of data quality issues as well as enabling downstream processing for tasks such as quantitative prediction or classification. To generate a data profile, Data Profiler 112 may use a deterministic program to detect dataset characteristics such as mean, minimum, maximum, percentiles, quartiles, and frequency for one or more features in the dataset. Data Profiler 112 may generate metadata based on the dataset describing, for example, the frequency of null values or the distributions of values for features. In some embodiments, Data Profiler 112 may perform dimensionality reduction in an exploration of the features in the dataset, for example using a principal component analysis technique. The resulting dimensions. Additionally, Data Profiler 112 may generate multivariate metadata including correlations between features such as covariance matrices. In some embodiments, Data Profiler 112 may build simple models such as linear regression models to explore the relationships between features.

To generate Data Profiles 132, Data Profiler 112 may perform some or all of the above operations to datasets. Data Profiler 112 may selectively apply some techniques to some datasets as needed. For example, the system may decide to seek a particular data profile attribute (e.g., Data Profile Attributes 134) from a dataset. The system may particularly need to know of the distribution of features in one dataset, for example, and be more interested in the covariance between features in a different dataset. Thus, the data profile may contain different set of data profile attributes. As referred to herein, a data profile attribute is a metric or other numeric representation generated for a data profile (such as one in Data Profiles 132), describing one or more aspects of the underlying dataset. Data profile attributes might be real values capturing the standard deviations for one or more features in a dataset, or the mean, minimum, maximum, percentiles, quartiles, or frequency distributions for features. Each data profile in Data Profiles 132 may correspond to one or more data profile attributes in Data Profile Attributes 134, stored in the computer system's memory.

At step 404, process 400 (e.g., using one or more components described above) trains a profile query model to generate responses to user queries relating to data profiles based on training data comprising data profile attributes from the data profiler. The system may receive training data containing a first set of features, which may be used as input by a machine learning model (e.g., Profile Query Machine Learning Model 114). The training data may include data profile attributes and user queries. For example, Profile Query Machine Learning Model 114 can be trained to produce responses to textual user queries through responses, where the user queries pertain to user profiles. The training data may transform past user queries into a text-token format. Each word, sentence, paragraph or other semantic element is represented as a text token, which may be translated to a real-valued embedding. Profile Query Machine Learning Model 114 is trained to process an input sequence of text tokens, for example in embedding format, and produce an output text sequence to serve as a response, for example answering the user's question regarding an aspect of a data profile. Profile Query Machine Learning Model 114 can be trained using algorithms such as deep neural networks or Bidirectional Encoder Representation Transformer algorithms. Profile Query Machine Learning Model 114 may be trained using the gradient descent or backpropagation parameter tuning method, and may be evaluated on a loss function assessing adherence to the training dataset. In some embodiments, Profile Query Machine Learning Model 114 may be trained in an unsupervised or semi-supervised learning scheme to produce responses to input queries.

At step 406, process 400 (e.g., using one or more components described above) receives a user query concerning one or more data profiles associated with the data profiler. The system may receive a user query regarding a data profile in Data Profiles 132. For example, the user query may pertain directly or indirectly to a data profile attribute in Data Profile Attributes 134. The user may submit a query to the system such as “What is the mean and standard deviation for square footage in the house value dataset?” or “Fit a linear regression model to predict house value. Show the parameters”. The user queries may be received similarly to the training data for Profile Query Machine Learning Model 114, being divided into word tokens and translated into real-valued embeddings. The user query's embedding may be used as input to Profile Query Machine Learning Model 114 to generate a preliminary response. Prior to doing so, however, the system may use an interpretation machine learning model to perform pre-processing in order to assess a plan of action regarding the user query.

At step 408, process 400 (e.g., using one or more components described above) pre-processes the user query and data profile attributes to determine an activation pattern for the profile query model using an interpretation model. The system may use an interpretation machine learning model (e.g., Interpretation Machine Learning Model 116) to determine an activation pattern appropriate for the user query. An activation pattern describes how Profile Query Machine Learning Model 114 generates a response to the user query. For example, the activation pattern describes the manner in which a machine learning model transforms its input values into an output. For example, an activation pattern may describe an algorithm used by the machine learning model to generate a text sequence in response to input values. In another example, an activation pattern may describe the parameters, weights, biases, and loss functions of a machine learning model used in computation. In some embodiments, the system may choose activation patterns from pre-set standard activation patterns. For example, the algorithm for a machine learning model may be chosen from standard options corresponding to categories of incoming user requests. An activation pattern may also describe additional software programs used to aid a machine learning model. For example, a machine learning model may use a clustering program to classify its inputs before the model does further processing to generate an output. In another example, an activation pattern may use a program to process its output into a format suitable for a preliminary response. For example, the machine learning model may generate an output indicating a piece of advice in a real-valued format. The system may wish to present the preliminary response in a text format, and may thus use an embedding program to translate the real-valued output of the machine learning model into the preliminary response.

Interpretation Machine Learning Model 116, in conjunction with other programs the system may interface with, may perform pre-processing of the user query in preparation for Profile Query Machine Learning Model 114 to generate the preliminary response. As referred to herein, pre-processing includes identifying supplemental data and formatting requirements. Additionally, the retrieval of the supplemental data may also be considered pre-processing. Supplemental data refers to data that may be used as input to a machine learning model that is not directly taken from the user query. For example, the system may seek to retrieve one or more attributes in Data Profile Attributes 134, perform basic data cleansing, and use the data for input to Profile Query Machine Learning Model 114. The data profile attributes may be used in generating a response to the user query. For example, for a query asking for a histogram of median values for a feature across datasets, Interpretation Machine Learning Model 116 may classify the query as visual generation based on data. Interpretation Machine Learning Model 116 may therefore find the raw data associated with the query, in this case, the median for the feature across the specified datasets. If the median is not present in Data Profile Attributes 134, Interpretation Machine Learning Model 116 may simply return the raw datasets with the feature. Otherwise, Interpretation Machine Learning Model 116 outputs the median for the features in the datasets for use by Profile Query Machine Learning Model 114 in generating a preliminary response.

The system may select activation patterns for Profile Query Machine Learning Model 114 by classifying the user query into a category using Interpretation Machine Learning Model 116. Interpretation Machine Learning Model 116 is trained to take a user query as input and, using an embedding map generated by training on a dataset of user queries, to translate the input query to a real-valued embedding. For example, Interpretation Machine Learning Model 116 may be provided with a set of pre-determined categories supplied through its training dataset. Interpretation Machine Learning Model 116 may be trained to classify an input user query, in real-valued embedding form, into a category in the set. Each category may be associated with an activation pattern. In some embodiments, Interpretation Machine Learning Model 116 may instead be trained to output an activation pattern directly. Additionally or alternatively, Interpretation Machine Learning Model 116 may also output a formatting requirement for the post-processing of the preliminary response into a verified response. The formatting requirement may specify requirements for privacy in the verified response, and may additionally include mathematical formulae used to determine the factual accuracy of the preliminary response.

At step 410, process 400 (e.g., using one or more components described above) uses the profile query model to process the user query and the one or more data profile attributes of the data profiler and generate a preliminary response. The system uses Profile Query Machine Learning Model 114 to generate a preliminary response by taking as input the real-valued embeddings representing the user query. Profile Query Machine Learning Model 114 may use a variety of algorithms such as deep neural networks and transformer-based text processing algorithms to perform next-token prediction in order to build a sequence of embeddings corresponding to a response. Profile Query Machine Learning Model 114 may be trained on data consisting of responses to user queries relating to data profile attributes, and its output during training consists of preliminary responses containing information about those data profile attributes. For example, Profile Query Machine Learning Model 114 produces “the median for square footage in the housing dataset is 800” in response to a query asking “what is the median square footage in this housing dataset?”. The preliminary response may contain text in natural language, but may also include descriptions of data profile attributes, or computed results based on data profiles. In some embodiments, the preliminary response may include graphics or other generated results the user query may request. Profile Query Machine Learning Model 114 may use its sequential token-processing architecture to generate responses to these other queries, incorporating what data from Data Profile Attributes 134 is deemed necessary based on its activation pattern.

At step 412, process 400 (e.g., using one or more components described above) post-processes the preliminary response to generate a verified response by applying a corrective program, wherein the verified response is checked for accuracy and confidentiality. The system post-processes the preliminary response to generate a verified response. The system may use a verification program (also referred to as a corrective program) to verify factual accuracy and confidentiality of the preliminary response. Interpretation Machine Learning Model 116 may also generate a formatting requirement for post-processing of the preliminary response by a corrective program. A formatting requirement, as referred to herein, is a restriction on the presentation of responses to user queries. Restrictions may include requirements for content of a response or the style of presentation for the response. For example, a formatting requirement may require the tone of a response to be suggestive and friendly rather than directive or dismissive. In another example, the formatting requirement may require the response to be free of identifying personal information out of privacy concerns for the user. In another example, the formatting requirement may adjust the confidence level of a response in order to avoid over-promising when executing a task. Formatting requirements may be used to inform the pre-processing or post-processing of the machine learning model before or after generating a preliminary response. The formatting requirement may also specify the factual accuracy of the preliminary response, to be confirmed using the user query. The formatting requirement generated by Interpretation Machine Learning Model 116 may specify that the verification program retrieve data profile attributes from Data Profile Attributes 134 and perform mathematical formulae to generate a real-valued result expected of the preliminary response as a factual accuracy check.

For example, the verification program may scan the verified response for any confidential information listed in a dataset of restricted information. For example, the verification program may remove any mention of restricted datasets, refusing all queries relating to the restricted data. In another example, the verification program may scrub the preliminary response of personally identifying information, such as names, home addresses, and similar personal data. Additionally or alternatively, the verification program may check the factual accuracy of the preliminary response by applying a mathematical formula to one or more data profile attributes. For example, the verification program may retrieve data in accordance with the formatting requirement from Data Profile Attributes 134. The verification program may retrieve a null type and a null value distribution from Data Profile Attributes 134. Based on the formatting requirement, the null value distribution must be sufficiently low and the null type must avoid certain core feature values in order for the system to consider the user query feasible. The verification program may determine a measure of correspondence with the activation pattern prescribed for Profile Query Machine Learning Model 114 indicating the degree of confidence the system has that the preliminary response is correct. If the measure of correspondence is below a threshold, the system may choose not to transmit the preliminary response and instead reject the user query. In another example, the system may use the mathematical formulae, combined with data profile attributes from Data Profiles 132, to calculate an expected result. The expected result is a real value associated with the user query that the verification program generates independently of Profile Query Machine Learning Model 114. The verification program may refer to the formatting requirement or activation patterns output by Interpretation Machine Learning Model 116 to choose a mathematical formula and required input data. It may perform a computation to determine the expected result for the user query, and compare the result extracted from the embedding of the preliminary response against the expected result. The system may correct the preliminary response to use the expected result in cases of difference.

At step 414, process 400 (e.g., using one or more components described above) transmits the verified response in a conversational program related to the user query. For example, the verified response (as edited by the post-processing of the verification program) may be transmitted in a conversational view to the user. It may contain descriptions of data profile attributes, processed statistics based on data profile attributes, or generated graphics responding to user queries. The user may submit a second query, which may relate to a different data profile attribute, inquire deeper into the response based on the information presented, or may re-state the initial user query if the user is not satisfied with the first response. The system may use the above-outlined process to generate a second response for the second user query, taking into account the context of the first response. For example, the system may select a different activation pattern in embodiments where the user requests a re-statement of an answer to the same query.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for interfacing with data profilers using a machine learning model, comprising: receiving a data profiler configured to create and store a plurality of data profile attributes; training a profile query model to interface with data profilers and generate responses to user queries relating to data profiles based on training data comprising data profile attributes from a plurality of data profiles and example user queries; receiving, in a conversational program, a user query requesting information regarding one or more data profile attributes of the data profiler; using a language interpretation model, pre-processing the user query and the one or more data profile attributes to determine an activation pattern for the profile query model, wherein the language interpretation model is trained to produce real-valued embeddings associated with the user query; using the profile query model, processing the real-value embeddings associated with the user query and the one or more data profile attributes to generate a preliminary response; post-processing the preliminary response to generate a verified response by applying a verification program to verify factual accuracy and confidentiality of the preliminary response; and transmitting the verified response in the conversational program related to the user query.
2. A method for interfacing with data profilers using a machine learning model, comprising: receiving a data profiler configured to create and interface with a plurality of data profiles; training a profile query model to generate responses to user queries relating to data profiles based on training data comprising data profile attributes from the data profiler; receiving a user query concerning one or more data profiles associated with the data profiler; using an interpretation model, pre-processing the user query and one or more data profile attributes of the data profiler to determine an activation pattern for the profile query model, wherein the interpretation model is trained to produce real-valued embeddings associated with user queries; using the profile query model to process the user query and the one or more data profile attributes of the data profiler and generate a preliminary response; post-processing the preliminary response to generate a verified response by applying a corrective program, wherein the verified response is checked for accuracy and confidentiality; and transmitting the verified response in a conversational program related to the user query.
3. A method comprising: receiving a library configured to create and interface with a plurality of data profiles; receiving a profile query model trained to answer user queries relating to data profiles based on data profile attributes; receiving a user query concerning one or more data profiles associated with the library; using an interpretation model, pre-processing the user query and one or more data profile attributes of the library to determine an activation pattern for the profile query model, wherein the interpretation model is trained to produce real-valued embeddings associated with user queries; use the profile query model to process the user query and the library and generate a response; transmitting the response in a conversational program related to the user query.
4. The method of any one of the preceding embodiments, wherein the interpretation model is a language processing model trained to correspond user queries to embeddings used as input to the profile query model.
5. The method of any one of the preceding embodiments, wherein the profile query model is trained to use embeddings as input to generate a text-based response to queries related to the data profiler.
6. The method of any one of the preceding embodiments, wherein the corrective program compares the activation pattern output by the interpretation model against data profile attributes to determine feasibility, comprising: using the data profiler, determining a null type and a null value distribution; based on the null type and the null value distribution, determining a measure of correspondence with the activation pattern, wherein the measure of correspondence indicates an extent of null values and null types in data required to complete the activation pattern; and based on measure of correspondence, determining a feasibility of the activation pattern.
7. The method of any one of the preceding embodiments, wherein the corrective program compares mathematical formulae output by the interpretation model against the preliminary response to determine accuracy, comprising: using the mathematical formulae and the plurality of data profiles, generate an expected result; extracting a reported result from an embedding of the preliminary response; and comparing the expected result against the reported result to determine a measure of accuracy.
8. The method of any one of the preceding embodiments, further comprising the corrective program using metadata of the data profiler to determine data integrity: based on privacy metadata associated with a data profile, determining a disclosable dataset, wherein the disclosable dataset comprises data in the data profile suitable for answering the user query; and modifying the preliminary response to contain only data from the disclosable dataset.
9. The method of any one of the preceding embodiments, further comprising training the interpretation model, comprising: generate a training dataset, comprising data profile descriptions in plain text; training the interpretation model using a language processing algorithm to generate real-valued embeddings corresponding to input text tokens; and based on real-valued embeddings, training the interpretation model to correlate embeddings to activation patterns.
10. The method of any one of the preceding embodiments, wherein the data profiler produces metadata attributes based on a dataset, including: a number of null values in the dataset; a range, median, and quartile values of the dataset; a standard deviation and skewness values of the dataset; and a variable type for each feature in the dataset.
11. The method of any one of the preceding embodiments, wherein the data profiler produces data structures based on a dataset, including: a histogram based on categories of feature values; an inferred distribution for one or more variables in the dataset; and a linear regression model based on the dataset.
12. The method of any one of the preceding embodiments, wherein determining the activation pattern for the profile query model comprises: determining supplemental data, wherein the supplemental data is computed based on the plurality of data profiles; determining an algorithm for the profile query model; and determining a mathematical formula from a set of mathematical formulae, wherein the mathematical formula is selected for applicability to the user query.
13. One or more non-transitory computer-readable media storing instructions that, when executed by a data processing apparatus, cause the data processing apparatus to perform operations comprising those of any of embodiments 1-12.
14. A system comprising one or more processors; and memory storing instructions that, when executed by the processors, cause the processors to effectuate operations comprising those of any of embodiments 1-12.
15. A system comprising means for performing any of embodiments 1-12.

What is claimed is:

1. A system for interfacing with data profilers using a machine learning model, the system comprising:
one or more processors; and
one or more non-transitory, computer-readable media comprising instructions that, when executed by the one or more processors, cause operations comprising:
receiving a data profiler configured to create and store a plurality of data profile attributes;
training a profile query model to interface with data profilers and generate responses to user queries relating to data profiles based on training data comprising data profile attributes from a plurality of data profiles and example user queries;
receiving, in a conversational program, a user query requesting information regarding one or more data profile attributes of the data profiler;
using a language interpretation model, pre-processing the user query and the one or more data profile attributes to determine an activation pattern for the profile query model, wherein the language interpretation model is trained to produce real-valued embeddings associated with the user query;
using the profile query model, processing the real-value embeddings associated with the user query and the one or more data profile attributes to generate a preliminary response;
post-processing the preliminary response to generate a verified response by applying a verification program to verify factual accuracy and confidentiality of the preliminary response; and
transmitting the verified response in the conversational program related to the user query.

2. A method for interfacing with data profilers using a machine learning model, comprising:
receiving a data profiler configured to create and interface with a plurality of data profiles;
training a profile query model to generate responses to user queries relating to data profiles based on training data comprising data profile attributes from the data profiler;
receiving a user query concerning one or more data profiles associated with the data profiler;
using an interpretation model, pre-processing the user query and one or more data profile attributes of the data profiler to determine an activation pattern for the profile query model, wherein the interpretation model is trained to produce real-valued embeddings associated with user queries;
using the profile query model to process the user query and the one or more data profile attributes of the data profiler and generate a preliminary response;
post-processing the preliminary response to generate a verified response by applying a corrective program, wherein the verified response is checked for accuracy and confidentiality; and
transmitting the verified response in a conversational program related to the user query.

3. The method of claim 2, wherein determining the activation pattern for the profile query model comprises:
determining supplemental data, wherein the supplemental data is computed based on the plurality of data profiles;
determining an algorithm for the profile query model; and
determining a mathematical formula from a set of mathematical formulae, wherein the mathematical formula is selected for applicability to the user query.

4. The method of claim 2, wherein the interpretation model is a language processing model trained to correspond user queries to embeddings used as input to the profile query model.

5. The method of claim 2, wherein the profile query model is trained to use embeddings as input to generate a text-based response to queries related to the data profiler.

6. The method of claim 2, wherein the corrective program compares the activation pattern output by the interpretation model against data profile attributes to determine feasibility, comprising:
using the data profiler, determining a null type and a null value distribution;
based on the null type and the null value distribution, determining a measure of correspondence with the activation pattern, wherein the measure of correspondence indicates an extent of null values and null types in data required to complete the activation pattern; and
based on measure of correspondence, determining a feasibility of the activation pattern.

7. The method of claim 2, wherein the corrective program compares mathematical formulae output by the interpretation model against the preliminary response to determine accuracy, comprising:
using the mathematical formulae and the plurality of data profiles, generate an expected result;
extracting a reported result from an embedding of the preliminary response; and
comparing the expected result against the reported result to determine a measure of accuracy.

8. The method of claim 2, further comprising the corrective program using metadata of the data profiler to determine data integrity:
based on privacy metadata associated with a data profile, determining a disclosable dataset, wherein the disclosable dataset comprises data in the data profile suitable for answering the user query; and
modifying the preliminary response to contain only data from the disclosable dataset.

9. The method of claim 2, further comprising training the interpretation model, comprising:
generate a training dataset, comprising data profile descriptions in plain text;
training the interpretation model using a language processing algorithm to generate real-valued embeddings corresponding to input text tokens; and
based on real-valued embeddings, training the interpretation model to correlate embeddings to activation patterns.

10. The method of claim 2, wherein the data profiler produces metadata attributes based on a dataset, including:
a number of null values in the dataset;
a range, median, and quartile values of the dataset;
a standard deviation and skewness values of the dataset; and
a variable type for each feature in the dataset.

11. The method of claim 2, wherein the data profiler produces data structures based on a dataset, including:
a histogram based on categories of feature values;
an inferred distribution for one or more variables in the dataset; and
a linear regression model based on the dataset.

12. One or more non-transitory computer-readable media comprising instructions that, when executed by one or more processors, cause operations comprising:
receiving a library configured to create and interface with a plurality of data profiles;
receiving a profile query model trained to answer user queries relating to data profiles based on data profile attributes;
receiving a user query concerning one or more data profiles associated with the library;
using an interpretation model, pre-processing the user query and one or more data profile attributes of the library to determine an activation pattern for the profile query model, wherein the interpretation model is trained to produce real-valued embeddings associated with user queries;
using the profile query model to process the user query and the library and generate a response;
transmitting the response in a conversational program related to the user query.

13. The one or more non-transitory computer-readable media of claim 12, wherein determining the activation pattern for the profile query model comprises:
determining supplemental data, wherein the supplemental data is computed based on the plurality of data profiles;
determining an algorithm for the profile query model; and
determining a mathematical formula from a set of mathematical formulae, wherein the mathematical formula is selected for applicability to the user query.

14. The one or more non-transitory computer-readable media of claim 12, wherein the interpretation model is a language processing model trained to correspond user queries to embeddings used as input to the profile query model.

15. The one or more non-transitory computer-readable media of claim 12, wherein n the profile query model is trained to use embeddings as input to generate a text-based response to queries related to the library.

16. The one or more non-transitory computer-readable media of claim 12, wherein a corrective program compares the activation pattern output by the interpretation model against data profile attributes to determine feasibility, comprising:
using the library, determining a null type and a null value distribution;
based on the null type and the null value distribution, determining a measure of correspondence with the activation pattern, wherein the measure of correspondence indicates an extent of null values and null types in data required to complete the activation pattern; and
based on measure of correspondence, determining a feasibility of the activation pattern.

17. The one or more non-transitory computer-readable media of claim 12, wherein a corrective program compares mathematical formulae output by the interpretation model against the response to determine accuracy, comprising:
using the mathematical formulae and the plurality of data profiles, generate an expected result;
extracting a reported result from an embedding of the response; and
comparing the expected result against the reported result to determine a measure of accuracy.

18. The one or more non-transitory computer-readable media of claim 12, wherein the instructions further comprise a corrective program using metadata of the library to determine data integrity:
based on privacy metadata associated with a data profile, determining a disclosable dataset, wherein the disclosable dataset comprises data in the data profile suitable for answering the user query; and
modifying the response to contain only data from the disclosable dataset.

19. The one or more non-transitory computer-readable media of claim 12, wherein the instructions further comprise training the interpretation model, comprising:
generate a training dataset, comprising data profile descriptions in plain text;
training the interpretation model using a language processing algorithm to generate real-valued embeddings corresponding to input text tokens; and
based on real-valued embeddings, training the interpretation model to correlate embeddings to activation patterns.

20. The one or more non-transitory computer-readable media of claim 12, wherein the library produces metadata attributes based on a dataset, including:
a number of null values in the dataset;
a range, median, and quartile values of the dataset;
a standard deviation and skewness values of the dataset; and
a variable type for each feature in the dataset.
